(19) United States
(12) Patent Application Publication
(10) Pub. No.: US 2014/0205847 A1
(43) Pub. Date: Jul. 24, 2014

(54) MULTILAYER BLOWN FILMS

(71) Applicant: NOVA Chemicals (International) S.A., Fribourg (CH)

(72) Inventor: Daniel J. Falla, Sarnia (CA)

(73) Assignee: NOVA Chemicals (International) S.A., Fribourg (CH)

(21) Appl. No.: 14/134,288

(22) Filed: Dec. 19, 2013

(30) Foreign Application Priority Data
Jan. 18, 2013 (CA) 2802732

(51) Int. Cl. B32B 27/32; B32B 37/16; B29C 67/00; B32B 37/15; B32B 27/08; B29C 47/06

(52) U.S. Cl. CPC B32B 27/327; B32B 27/08; B29C 47/065; B29C 67/0014; B32B 37/153; B32B 37/16
USPC 428/476.9; 428/523; 428/516; 428/483; 264/510; 156/244.21

(57) ABSTRACT

Coextruded multilayer blown films are produced comprising: a core layer comprising at least one random polypropylene copolymer; at least one skin or intermediate layer adjacent to said core layer; wherein the coextruded multilayer film has at least about 30% higher machine direction tear, at least about 30% improved tear ratio (machine direction tear divided by transverse direction tear) and at least about 10% lower film haze, relative to a similar multilayer film comprising at least one impact polypropylene copolymer in the core layer.

### FIELD OF INVENTION

This invention relates to new designs for multilayer plastic films having improved machine direction tear, improved tear ratio (machine direction tear divided by transverse direction tear) and improved (lower) film haze.

### BACKGROUND OF INVENTION

Multilayer film processing technologies allow the package designer to combine chemically distinct materials into a composite web. In this way, the designer can take full advantage of the inherent physical properties of each distinct material. Using multilayer technology the designer can incorporate very specific physical properties into the final composite web; non-limiting examples include a barrier to oxygen and/or water vapor, impact resistance, stiffness or flexibility, scratch resistance, high clarity, high tear resistance and sealability. In general, such a wide range of physical properties cannot be delivered by one polymer in a monolayer packaging film. In addition, a monolayer film containing a blend of chemically distinct polymers is generally inferior to a multilayer composite; this reflects the fact that the desired physical properties inherent within each polymer are diluted by the other polymers in the blend. In addition, chemically distinct polymers are typically incompatible, thus, in many cases blending is not a practical solution.

The need exists to for improved packaging films, for example, inventive films with improved tear and optical properties. Also useful would be a process that eliminates the complexities of biaxial orientation after film production orientation, i.e., re-heating the multilayer film, biaxially stretching or orienting the multilayer film and thermo-fixing the multilayer film.

### SUMMARY OF THE INVENTION

One embodiment of the present invention provides a three layer film comprising a core layer comprising at least one random polypropylene copolymer (RCP), an inner skin layer adjacent to said core layer, and an outer skin layer adjacent to said core layer; wherein the coextruded film has improved machine direction tear, as determined by ASTM D-1922, that is at least about 30% higher compared with a similar film where the core layer is comprised of at least one impact polypropylene copolymer. Said three layer film also has an improved tear ratio, as determined by ASTM D-1922, of at least about 30% higher compared with a similar three layer film where the core layer is comprised of at least one impact polypropylene copolymer. Tear ratio is defined by the dividing the machine direction tear by the transverse direction tear (MD tear/TD tear). Said three layer film also has at least about 10% lower film haze, as determined by ASTM D-1003, compared with a similar film where the core layer is comprised at least one impact polypropylene copolymer. Said inner skin layer and said outer skin layer are comprised of at least one ethylene interpolymer; optionally, said inner and said outer skin layers may differ in chemical composition.

The multilayer films disclosed herein do not require a blend of polypropylene and polyethylene in the core to deliver the required adhesion between the core and the skin or intermediate layers.

### DEFINITION OF TERMS

Other than in the operating examples or where otherwise indicated, all numbers or expressions referring to quantities of ingredients, extrusion conditions, etc., used in the specification and claims are to be understood as modified in all instances by the term “about.” Accordingly, unless indicated to the contrary, the numerical parameters set forth in the following specification and attached claims are approximations that can vary depending upon the desired properties, which the various embodiments of the present invention desires to obtain. At the very least, and not as an attempt to limit the application of the doctrine of equivalents to the scope of the claims, each numerical parameter should at least be construed in light of the number of reported significant digits and by applying ordinary rounding techniques.

It should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

In order to form a more complete understanding of the invention the following terms are defined and should be used with the accompanying figures and the description of the various embodiments throughout.

As used herein, the term “monomer” refers to a small molecule that may chemically react and become chemically bonded with itself or other monomers to form a polymer.

As used herein, the term “polymer” refers to macromolecules composed of one or more monomers connected together by covalent chemical bonds. The term polymer is meant to encompass, without limitation, homopolymers, copolymers, terpolymers, quatropolymers, multi-block polymers, graft copolymers, and blends and combinations thereof.

The term “homopolymer” refers to a polymer that contains one type of monomer.

The term “copolymer” refers to a polymer that contains two monomer molecules that differ in chemical composition randomly bonded together. The term “terpolymer” refers to a polymer that contains three monomer molecules that differ in chemical composition randomly bonded together. The term “quatropolymer” refers to a polymer that contains four monomer molecules that differ in chemical composition randomly bonded together.

As used herein, the term “ethylene polymer”, refers to macromolecules produced from the ethylene monomer and optionally one or more additional monomers. The term ethylene polymer is meant to encompass, ethylene homopolymers, copolymers, terpolymers, quatropolymers, block copolymers and blends and combinations thereof, produced using any polymerization processes and any catalyst.

Common ethylene polymers include high density polyethylene (HDPE), medium density polyethylene (MDPE), linear low density polyethylene (LLDPE), very low density polyethylene (VLDPE), ultralow density polyethylene (ULDPE), plastomer and elastomers; as well as ethylene polymers produced in a high pressure polymerization processes, commonly called low density polyethylene (LDPE), ethylene vinyl acetate copolymers (EVA), ethylene alkyl acrylate copolymers, ethylene acrylic acid copolymers and metal salts of ethylene acrylic acid (commonly referred to as ionomers).

The term “ethylene interpolymer” refers to a subset of the polymers in the “ethylene polymer” grouping that excludes ethylene homopolymers and ethylene polymers produced in a high pressure polymerization processes.

The term “heterogeneously branched ethylene interpolymers” refers to a subset of polymers in the “ethylene interpolymer” group characterized by a broad composition distribution breadth index (CDBI) of about 50% or less has determined by temperature rising elution fractionation (TREF). Heterogeneously branched ethylene interpolymers may be produced by, but are not limited to, Ziegler-Natty catalysts. Experimental methods, such as TREF, which are used to determine the CDBI of an ethylene polymer are well known to individuals experienced in the art. For example, as described in Wild et al., “Determination of Branching Distributions in Polyethylene and Ethylene Copolymers” Journal of Polymer Science: Polymer Physics Edition, 20,441-455(1982); or as described in U.S. Pat. No. 5,008,204 assigned to Exxon Chemical Patents, and; the definition of CDBI is fully described in WO 93/03093, applicant Exxon Chemical Patents Inc.

The term “homogeneous ethylene interpolymer” refers to a subset of polymers in the “ethylene interpolymer” group characterized by a narrow composition distribution breadth index (CDBI) of about 50% or more as determined by temperature rising elution fractionation (TREF). Homogeneous ethylene interpolymers may be produced by, but not limited to, single site catalysts or metallocene catalysts. It is well known to those skilled in the art, that homogeneous ethylene interpolymers are frequently further subdivided into “linear homogeneous ethylene interpolymers” and; “substantially linear homogeneous ethylene interpolymers”. These two subgroups differ in the amount of long chain branching: more specifically, linear homogeneous ethylene interpolymers have an undetectable amount of long chain branching; while substantially linear ethylene interpolymers have a small amount of long chain branching, typically from about 0.01 long chain branches/1000 carbons to about 3 long chain branches/1000. A long chain branch is defined as a branch having a chain length that is macromolecular in nature, i.e., the length of the long chain branch can be similar to the length of the polymer back-bone to which it is attached. Typically, the amount of long chain branching is quantified using Nuclear Magnetic Resonance (NMR) spectroscopy, as described in Randall “A Review of High Resolution Liquid 13C NMR of Ethylene Based Polymers”, J. Macromol. Sci., Rev. Macromol. Chem. C29(2-3), 201-317 (1989). In this invention, the term homogeneous ethylene interpolymer refers to both linear homogeneous ethylene interpolymers and substantially linear homogeneous ethylene interpolymers.

The term “Ziegler-Natta catalyst” refers to a catalyst system that produces heterogeneous ethylene interpolymers. Ziegler-Natta systems generally contain, but not limited to, a transition metal halide, typically titanium, (e.g. TiCl4), or a titanium alkoxide (Ti(OR)₄) where R is a lower C₁₋₄ alkyl radical) on a magnesium support (e.g. MgCl₂ or BEM (butyl ethyl magnesium) halogenated (with for example CCl₄) to MgCl₂) and an activator, typically an aluminum compound (AlX₄ where X is a halide, typically chloride), a tri alkyl aluminum (e.g. AlR₃ where R is a lower C₁₋₈ alkyl radical (e.g., trimethyl aluminum), (RO)ₐAlX₃₋ₐ where R is a lower C₁₋₄ alkyl radical, X is a halide, typically chlorine, and a is an integer from 1 to 3 (e.g. diethoxide aluminum chloride), or an alkyl aluminum alkoxide (e.g., RₐAl(OR)₃₋ₐ where R is a lower C₁₋₄ alkyl radical and a is as defined above (e.g. ethyl aluminum diethoxide). The catalyst may include an electron donor such as an ether (e.g. tetrahydrofuran etc.). There is a large amount of art disclosing these catalyst and the components and the sequence of addition may be varied over broad ranges.

The term “single site catalyst” refers to a catalyst system that produces homogeneous ethylene interpolymers. There is a large amount of art disclosing single site catalyst systems, a non-limiting example includes a bulky ligand single site catalyst of the formula:

(L)ₙ-M-(Y)ₚ

wherein M is selected from Ti, Zr, and Hf; L is a monoanionic ligand independently selected from cyclopentadienyl-type ligands, and a bulky heteroatom ligand containing not less than five atoms in total (typically of which at least about 20%, or at least about 25% numerically are carbon atoms) and further containing at least one heteroatom selected from boron, nitrogen, oxygen, phosphorus, sulfur and silicon, said bulky heteroatom ligand being sigma or pi-bonded to M; Y is independently selected from activatable ligands; n may be from 1 to 3; and p may be from 1 to 3, provided that the sum of n+p equals the valence state of M, and further provided that two L ligands may be bridged.

As used herein, the term “polyolefin” refers to a broad class of polymers that includes polyethylene and polypropylene.

As used herein, the term “polypropylene” includes isotactic, syndiotactic and atactic polypropylene homopolymers, random propylene copolymers containing one comonomer, random propylene terpolymers containing two comonomers, random propylene quatropolymers containing three comonomers and impact polypropylene copolymers or heterophasic polypropylene copolymers.

The following two equivalent terms, “random polypropylene copolymer” or “RCP” refer to polypropylenes that contain less than about 20 wt % of comonomer, based on the weight of the random polypropylene copolymer; typical comonomers include, but are not limited to, ethylene and C₄ to C₁₂ α-olefins. Random polypropylene copolymers may also contain two or more comonomers.

The following three equivalent terms, “heterophasic polypropylene copolymer” or “impact polypropylene copolymer” or “ICP” refer to polypropylenes that contain up to about 40 wt % of an ethylene/propylene rubber finely dispersed in a propylene homopolymer or a random polypropylene copolymer. The ethylene/propylene rubber may also include one or more of the following monomers; 1,2-propadiene, isoprene, 1,3-butadiene, 1-5-cyclooctadiene, norbornadiene or dicyclopentadiene.

As used herein, the term “thermoplastic” refers to polymers that soften or become liquid when heated, will flow under pressure and harden when cooled. Thermoplastic polymers include polyolefins as well as other polymers commonly used in film applications; non-limiting examples include barrier resins, tie resins, polyethylene terephthalate (PET) and polyamides.

As used herein, the term “barrier resin” refers to a thermoplastic that when formed into an intermediate layer within a multilayer film structure reduces the permeability of the multilayer film structure, relative a film that does not contain the intermediate layer comprised of the barrier resin. Non-limiting examples of permeates where reduced permeability is desired include water and oxygen. As a non-limiting example, in food packaging applications the barrier layer within a multilayer film protects food or drink from the deleterious effects of moisture and/or oxygen. Water vapor transmission rates (WVTR) of films are typically determined using ASTM F 1249-06. Oxygen gas transmission rates of films are typically determined using ASTM F2622-08.

As used herein, the term “tie resin” refers to a thermoplastic that when formed into an intermediate layer, or a “tie layer” within a multilayer film structure, promotes adhesion between adjacent film layers that are dissimilar in chemical composition.

As used herein the term “monolayer film” refers to a film containing a single layer of one or more thermoplastics.

As used herein the term “multilayer film” refers to a film comprised of more than one thermoplastic layer, or optionally non-thermoplastic layers. Non-limiting examples of non-thermoplastic materials include metals (foil) or cellulosic (paper) products. One or more of the thermoplastic layers within a multilayer film may be comprised of more than one thermoplastic.

In coextrusions the following nomenclature is typically used to designate a 5-layer coextruded film: A/B/C/D/E; wherein each uppercase letter refers to a chemically distinct layer. The central layer, layer C is typically called the “core layer”; similarly, three layer, seven layer, nine layer and eleven layer films, etc., have a central core layer. In a five layer multilayer film with the structure A/B/C/D/E, layers A and E are typically called the “skin layers” and layers B and D are typically called “intermediate layers”. In the case of a five layer film with the structure A/B/C/B/A; the chemical composition of the two “A” skin layers are identical, similarly the chemical composition of the two intermediate “B” layers are identical.

As used herein, the term “sealant layer” refers to a layer of thermoplastic film that is capable of being attached to a second substrate, forming a leak proof seal.

As used herein, the term “adhesive lamination” and the term “extrusion lamination” describes continuous processes through which two or more substrates, or webs of material, are combined to form a multilayer product or sheet; wherein the two or more webs are joined using an adhesive or a molten thermoplastic film, respectively.

As used herein, the term “extrusion coating” describes a continuous process through which a molten thermoplastic layer is combined with, or deposited on, a moving solid web or substrate. Non-limiting examples of substrates include paper, paperboard, foil, monolayer plastic film, multilayer plastic film or fabric. The molten thermoplastic layer could be monolayer or multilayer.

Herein, polymer densities were determined using American Society for Testing and Materials (ASTM) methods ASTM D1505 or D792.

Herein, polymer melt index was determined using ASTM D1238, Condition I was measured at 190° C., using a 2.16 kg weight and Condition G was measured at 230° C., using a 2.16 kg weight.

Herein, film dart impact strength was determined using ASTM D-1709B.

Herein, film puncture resistance, the energy (J/mm) to break the film, was determined using a 0.75-inch (1.9-cm) diameter pear-shaped fluorocarbon coated probe travelling at 10-inch per minute (25.4-cm/minute). The probe was mounted in an Instron Model 5 SL Universal Testing Machine and a 1000-N load cell as used.

Herein, film machine direction and transverse direction Elmendorf tear strength and tensile strength was determined using ASTM D-1922 and ASTM D882, respectively.

Herein, the term “tear ratio” is defined by the dividing the machine direction tear by the transverse direction tear (MD tear/TD tear); wherein tear is determined by ASTM D-1922. The tear measured using this test method is commonly called Elmendorf tear.

Herein, film machine direction and transverse direction tensile properties (about 1% secant modulus, about 2% secant modulus, tensile strength at yield, tensile strength at break, tensile elongation at break) were determined using ASTM D882.

Herein, film optical properties were measured as follows: Haze, ASTM D1003; Clarity ASTM D1746 and; Gloss ASTM D2457.

Herein, the flexural moduli of injection molded plaques were measured using ASTM D-790A.

Herein the notched IZOD of injection molded plaques were measured using ASTM D-256A.

Herein, the Gardner impact strength of injection molded plaques was measured using ASTM D-5420G.

### DESCRIPTION OF THE FIGURES

FIG. 1 compares the tear ratio (MD/TD), the normalized MD tear, the normalized inverse haze and the normalized average hot tack of seven 3-layer coextruded blown films; the labels In.1 and Ex.2 refer to Inventive 1 and Example 2, etc., as described in the specification. Inventive 1 denotes the inventive film; while Examples 2 through Example 7 are comparative examples. The tear ratio was calculated by dividing the machine direction (MD) tear by the transverse direction (TD) tear (MD tear/TD tear); wherein tear was determined by ASTM D-1922 (Elmendorf tear). Normalized MD tear was calculated by dividing the MD tear of each coextruded film by the MD tear of Inventive 1. Film haze was measured using ASTM D1003. The normalized inverse haze was calculated by dividing the inverse haze (1/haze^{ASTMD1003}) of each coextruded film by the inverse haze of Inventive 1. Film hot tack was measured using a J&B Hot Tack Tester as described in the specification. The normalized average hot tack was calculated by dividing the average hot tack of each coextruded film by the average hot tack of Inventive 1.

FIG. 2 compares the hot tack of seven 3-layer coextruded blown films. In.1 (Inventive 1) denotes the inventive film; while Examples 2 through Example 7 are comparative examples. Film hot tack was measured using a J&B Hot Tack Tester as described in the specification; hot tack measurements were recorded at temperature increments of 9° F. (5° C.).

FIG. 3 compares the heat seal strength of seven 3-layer coextruded blown films. In.1 (Inventive 1) denotes the inventive film; while Examples 2 through Example 7 are comparative examples. Film heat seal strength was measured using a conventional Instron Tensile Tester, as described in the specification; heat seal measurements were recorded at temperature increments of 9° F. (5° C.).

### DETAILED DESCRIPTION OF THE INVENTION

One particular embodiment of the present invention provides a three layer film comprising a core layer comprising at least one random polypropylene copolymer (RCP), an inner skin layer adjacent to said core layer, and an outer skin layer adjacent to said core layer; wherein the coextruded film has improved machine direction tear, as determined by ASTM D-1922, that is at least about 30% higher compared with a similar three layer film where the core layer is comprised of at least one impact polypropylene copolymer. Said inventive three layer film also has an improved tear ratio, as determined by ASTM D-1922, of at least about 30% higher compared with a similar three layer film where the core layer is comprised of at least one impact polypropylene copolymer. Said inventive three layer film also has at least about 10% lower film haze, as determined by ASTM D-1003, compared with a similar film where the core layer is comprised of at least one impact polypropylene copolymer. The inner skin layer and the outer skin layer of said inventive three layer film are comprised of at least one ethylene interpolymer; optionally, said inner and said outer skin layers may differ in chemical composition.

The random polypropylene copolymer embodied in this invention has a melt index of at least about 0.5 g/10 minutes, in some cases at least about 1 g/10 minutes and in other cases at least about 2 g/10 minutes, and; can be up to about 16 g/10 minutes, and in some cases up to about 10 g/10 minutes and in other cases up to about 5 g/10 minutes, as determined by ASTM D-1238 at 230° C. and 2.16 kg. The random polypropylene copolymer has a density of at least about 0.88 g/cm³, in some cases at least about 0.89 g/cm³ and in other cases at least about 0.90 g/cm³, and; can be up to about 0.915 g/cm³, in some cases up to about 0.91 g/cm³ and other cases up to about 0.895 g/cm³, as measured by ASTM D1505.

In some cases the random polypropylene copolymer is a copolymer, wherein the comonomer is selected from ethylene and α-olefin; wherein the α-olefin is linear or branched C₄ to C₁₂. In other cases the random polypropylene copolymer is a terpolymer containing any two comonomers selected from ethylene and α-olefin; wherein the α-olefin is linear or branched C₄ to C₁₂. The random polypropylene copolymer can be produced in a variety of polymerization processes; non-limiting examples include gas phase polymerization, slurry polymerization, bulk polymerization and solution polymerization. The random polypropylene copolymer can by synthesized by a variety of catalysts; non-limiting examples include Ziegler-Natta catalyst, single site catalysts and metallocene catalysts.

In addition to the core layer, comprised of at least one random polypropylene copolymer, the inventive three layer film also comprises an inner and outer skin layer. The inner and outer skin layers comprise at least one ethylene interpolymer. The inner and outer skin layers may, or may not, have the same chemical composition.

The ethylene interpolymers embodied in this invention have a melt index of at least about 0.1 g/10 minutes, in some cases at least about 0.4 g/10 minutes, in other cases at least about 1 g/10 minutes and in other instances at least about 2 g/10 minutes and; can be up to about 15 g/10 minutes, and in some cases up to about 12 g/10 minutes and in other cases up to about 8 g/10 minutes, as determined by ASTM D-1238 at 190° C. and 2.16 kg. The ethylene interpolymer has a density of at least about 0.865 g/cm³, in some cases at least about 0.88 g/cm³ and in other cases at least about 0.90 g/cm³, and; can be up to about 0.94 g/cm³, in some cases up to about 0.93 g/cm³ and other cases up to about 0.92 g/cm³, as measured by ASTM D1505. The ethylene interpolymer can be produced in a variety of polymerization processes; non-limiting examples include gas phase polymerization, slurry polymerization and solution polymerization. The ethylene interpolymer can be synthesized by a variety of catalysts; non-limiting examples include Ziegler-Natta catalysts, single site catalysts and metallocene catalysts. Ethylene interpolymers produced using Ziegler-Natta catalysis are commonly referred to as heterogeneous ethylene interpolymers. Ethylene interpolymers produced using single site catalysis or metallocene catalysts are commonly referred to as homogeneous ethylene interpolymers. Embodiments of this invention include ethylene interpolymer containing one or more comonomers selected from propylene and α-olefin; wherein the α-olefin is linear or branched C₄ to C₁₂. In the embodiments of this invention, the term homogeneous ethylene interpolymers includes homogeneous ethylene interpolymers which may, or may not, contain long chain branching.

In one embodiment of this invention, the inner and outer skin layer of the inventive three layer film may comprise a blend of at least one homogeneous ethylene interpolymer and at least one heterogeneous ethylene interpolymer; optionally, the inner and outer skin layers my differ in chemical composition.

In other embodiments of this invention the inner and/or the outer skin layer of the inventive three layer film may comprise at least one ethylene interpolymer and an ethylene polymer produced in a high pressure polyethylene process; wherein the ethylene polymer produced in a high pressure process has a melt index from about 0.2 g/10 minutes to about 10 g/10 minutes, as determined by ASTM D-1238 at 190° C. and 2.16 kg, and a density from about 0.917 g/cm3 to about 0.97 g/cm3, as determined by ASTM D-1505. Non-limiting examples of high pressure ethylene polymers include: low density polyethylene (LDPE), ethylene vinyl acetate copolymers (EVA), ethylene alkyl acrylate copolymers, ethylene acrylic acid copolymers and metal salts of ethylene acrylic acid (commonly referred to as ionomers). Optionally, the inner and/or the outer skin layer of the inventive three layer film may differ in chemical composition; more specifically, the ethylene interpolymers and/or the ethylene polymer produced in a high pressure process may differ in the inner layer and the outer layer of the inventive three layer film.

In other embodiments of this invention the inner and outer skin layer may comprise at least one ethylene interpolymer blended with at least one other ethylene polymer; wherein the ethylene polymer is a high density polyethylene (HDPE); optionally, the inner and outer skin layers may differ in chemical composition. The HDPE has a melt index of at least about 0.1 g/10 minutes, in some cases at least about 0.5 g/10 minutes and in other cases at least about 1 g/10 minutes, and; can be up to about 15 g/10 minutes, and in some cases up to about 12 g/10 minutes and in other cases up to about 8 g/10 minutes, as determined by ASTM D-1238 at 190° C. and 2.16 kg. The density of the HDPE ranges from about 0.96 g/cm³ to about 0.98 g/cm³, as measured by ASTM D1505.

Embodiments of the present invention include a five, a seven, a nine and an eleven layer coextruded film comprising a core layer comprising at least one random polypropylene copolymer and at least one intermediate layer adjacent to said core layer: wherein said coextruded multilayer film has improved machine direction tear, as determined by ASTM D-1922, that is at least about 30% higher compared with a core layer comprising at least one impact polypropylene copolymer; wherein said coextruded film has at least about 10% lower film haze, as determined by ASTM D-1003, compared with a core layer comprising at least one impact polypropylene copolymer; wherein said coextruded multilayer film has an improved tear ratio, as determined by ASTM D-1922, of at least about 30% higher compared with a core layer comprising at least one impact polypropylene copolymer.

Five, seven, nine and eleven layer films allow one to incorporate additional functionality into the final film structure; non-limiting examples of additional functionality include, a barrier layer, a higher modulus layer to increase stiffness, a lower modulus layer to increase flexibility, a tie layer to promote adhesion between dissimilar materials, a toughness layer, an external abuse resistance layer, an external scratch resistance layer, a decoration layer containing print or graphics or a sealant layer.

Barrier layers protect the package contents from the deleterious effects of a specific permeate. As a non-limiting example, in food packaging applications, barrier layers are typically used to reduce the permeation rates of water and oxygen; the barrier layer significantly increases the shelf-life of the food product. Non-limiting examples of thermoplastic barrier resins include: polyvinylalcohol (PVOH), ethylene vinyl alcohol (EVOH), polyamides (Nylon), polyesters, polyvinylidene chloride (PVDC), polyacrylonitrile and acrylonitrile copolymers and polyvinylchloride (PVC). Barrier layers may also include a layer of thermoplastic film upon which a metal oxide has been applied by chemical vapor deposition; for example a thin silicon oxide (SiOₓ) or aluminum oxide (AlOₓ) layer vapor deposited on polypropylene, polyamide or polyethylene terephthalate.

Non-limiting examples of tie resins which can be coextruded into tie-layers are functionalized polyethylenes containing monomer units derived from C₄ to C₈ unsaturated anhydrides, or monoesters of C₄ to C₈ unsaturated acids having at least two carboxylic acid groups, or diesters of C₄ to C₈ unsaturated acids having at least two carboxylic acid groups, or mixtures thereof. Tie layers in multilayer films typically contain less than about 20 wt % of a tie resin blended with a polyolefin; non-limiting examples of polyolefins include ULDPE, VLDPE, LLDPE, MDPE, HDPE, LDPE or polypropylenes. Depending on the chemical composition of the layers within multilayer film structure, the following non-limiting resins may also be effective as tie resins; ethylene/vinyl acetate copolymers, ethylene/methyl acrylate copolymers, ethylene/butyl acrylate copolymers, very low density polyethylene (VLDPE), ultralow density polyethylene (ULDPE), plastomers, elastomers, as well as single site catalyzed ethylene/α-olefin copolymers.

Non-limiting examples of resins which can be coextruded to produce a higher modulus layers include: polyamides (Nylon), polyethylene terephthalate, polyesters, polypropylenes, polycarbonates, polyphenylene oxides, polystyrene, styrenic copolymers, styrenic block copolymers, intercalated polymers and mixtures thereof. As used herein, the term “intercalated” refers to the insertion of one or more polymer molecules within the domain of one or more other polymer molecules having a different composition. In the embodiments of this invention, the term “intercalated polymer” refers to a styrenic polymer intercalated within polyolefin particles, produced by polymerizing a styrenics monomer mixture within a polyolefin particle. U.S. Pat. No. 7,411,024, U.S. Pat. No. 7,906,589, U.S. Pat. No. 8,101,686 and U.S. Pat. No. 8,168,722 are herein incorporated by reference in their entirety, describing intercalated polymers comprised of about 20 wt % to about 60 wt % of a polyolefin and from about 40 wt % to about 80 wt % of a styrenic polymer, based on the weight to the intercalated polymer. The random polypropylene copolymer used in the five, seven, nine and eleven layer coextruded films has a melt index, from about 0.5 g/10 minutes to about 16 g/10 minutes, as determined by ASTM D-1238 at 230° C. and 2.16 kg, and a density from about 0.89 g/cm³ to about 0.91 g/cm³, as determined by ASTM D-1505. The random polypropylene copolymer is a copolymer containing a comonomer selected from ethylene and α-olefin; wherein the α-olefin is linear or branched C₄ to C₁₂. In other embodiments, the random polypropylene is a terpolymer containing any two comonomers selected from ethylene and α-olefin; wherein the α-olefin is linear or branched C₄ to C₁₂. It is well known to those experienced in the art that random polypropylenes can be synthesized using a variety of catalyst systems; non-limiting examples included single site or Ziegler Natta catalysts.

The five, seven, nine and eleven layer extruded films of this invention also comprise an intermediate layer adjacent to said core layer, comprising at least one ethylene interpolymer. The ethylene interpolymer may comprise at least one homogeneous ethylene interpolymer having a melt index from about 0.1 g/10 minutes to about 15 g/10 minutes, as determined by ASTM D-1238 at 190° C. and 2.16 kg, and a density from about 0.9 g/cm3 to about 0.94 g/cm3, as determined by ASTM D-1505. In the embodiments of this invention, the term homogeneous ethylene interpolymers includes homogeneous ethylene interpolymers which may or may not contain long chain branching. In another embodiment the ethylene interpolymer may also comprise at least one heterogeneous ethylene interpolymer having a melt index from about 0.1 g/10 minutes to about 15 g/10 minutes, as determined by ASTM D-1238 at 190° C. and 2.16 kg, and a density from about 0.9 g/cm³ to about 0.94 g/cm³, as determined by ASTM D-1505. In another embodiment the ethylene interpolymer may comprise a blend of at least one homogeneous interpolymer and at least one heterogeneous interpolymer. In the embodiments of this invention, the ethylene interpolymer contains one or more comonomers selected from propylene and α-olefin; wherein the α-olefin is linear or branched C₄ to C₁₂. In another embodiment of this invention the intermediate layer adjacent to said core layer may comprise at least one ethylene interpolymer and an ethylene polymer produced in a high pressure polyethylene process; wherein the ethylene polymer produced in a high pressure process has a melt index from about 0.2 g/10 minutes to about 10 g/10 minutes, as determined by ASTM D-1238 at 190° C. and 2.16 kg, and a density from about 0.917 g/cm³ to about 0.97 g/cm³, as determined by ASTM D-1505. Non-limiting examples of high pressure ethylene polymers include: low density polyethylene (LDPE), ethylene vinyl acetate copolymers (EVA), ethylene alkyl acrylate copolymers, ethylene acrylic acid copolymers and metal salts of ethylene acrylic acid (commonly referred to as ionomers).

The multilayer thermoplastic films of this invention can be produced using a blown film or a cast film processes.

The blown film coextrusion process employs multiple extruders which heat, melt, mix and convey the various thermoplastics. Once molten, the various thermoplastics are pumped through an annular die adapted to accept multiple thermoplastic feeds and produce an extruded multilayer thermoplastic tube. Typical extrusion temperatures are from about 330° F. to about 550° F. (about 166° C. to about 288° C.) and especially from about 350° F. to about 530° F. (about 177° C. to about 277° C.). Upon exit from the annular die, the multilayer thermoplastic tube is inflated with air, cooled, solidified and pulled through a pair of nip rollers. Due to air inflation, the tube increases in diameter forming a bubble of desired size. Due to the pulling action of the nip rollers the bubble is stretched in the machine direction. Thus, the bubble is stretched in two directions: in the cross direction where the inflating air increases the diameter of the bubble; and in the machine direction where the nip rollers stretch the bubble. As a result, the physical properties of multilayer blown films are typically anisotropic, wherein the physical properties differ in the machine and cross directions; for example, film tear strength and tensile properties. In the blown film process, external air is also introduced around the bubble circumference to cool the thermoplastic as it exits the annular die. The final width of the film is determined by controlling the inflating air or the internal bubble pressure; in other words, increasing or decreasing bubble diameter. Film thickness is controlled primarily by increasing or decreasing the speed of the nip rollers to control the draw-down rate. After exiting the nip rollers, the bubble as a tube has been collapsed into two layers of film. The multilayer bubble or tube may be slit in the machine direction thus creating sheeting. Each sheet may be wound into a roll of film. Each roll may be further slit to create film of the desired width. Each roll of film is further processed into a variety of consumer products, e.g., printed, cut and sealed into bags or pouches. While not wishing to be bound by theory, it is generally believed by those skilled in the blown film art that the physical properties of the finished films are influenced by both the physical properties of the individual thermoplastics, or thermoplastic blends that comprise the each layer, as well as the blown film processing conditions. For example, blown film processing conditions are thought to influence the degree of molecular orientation (in both the machine direction and the cross direction). In general, a balanced film is most desirable; more specifically, a balanced film has similar physical properties in both the machine direction and the cross direction; for example, film tear strength properties, tensile properties or shrink properties.

The cast film process is similar in that multiple extruders are used; however the various thermoplastic materials are metered into a flat die and extruded into a multilayer sheet, rather than a tube. In the cast film process the extruded sheet is solidified on a chill roll.

Depending on the application, the multilayer films of this invention may be produced with a wide range of thicknesses. For example, in a non-limiting application such as food packaging, film thicknesses ranging from about 1 mil (about 25.4 μm) to about 4 mil (about 102 μm) are common; while in other non-limiting applications such as heavy duty sacks, film thicknesses ranging from about 2 mil (about 51 μm) to about 10 mil (about 254 μm) are common. The embodiments of this invention include films where each individual layer of the multilayer film comprises at least about 10%, in some cases at least about 15% and in other cases at least about 20% of the total film thickness. In other embodiments, each individual layer of the multilayer film comprises up to about 90%, in some cases up to about 80% and in other cases up to about 70% of the total film thickness.

Additional embodiments of this invention include the further processing of the inventive multilayer film in extrusion lamination or adhesive lamination or extrusion coating processes. In extrusion lamination or adhesive lamination, two or more substrates are bonded together with a thermoplastic or an adhesive, respectively. In extrusion coating, a thermoplastic is applied to the surface of a substrate. Extrusion lamination, adhesive lamination and extrusion coating are well known processes, as described in: “Extruding Plastics—A Practical Processing Handbook”, D. V. Rosato, 1998, Springer-Verlag, pages 441-448. Frequently, adhesive lamination or extrusion lamination are used to bond dissimilar materials, non-limiting examples include the bonding of a paper web to a thermoplastic web, or the bonding of an aluminum foil containing web to a thermoplastic web, or the bonding of two thermoplastic webs that are chemically incompatible. The individual webs, prior to lamination, may be multilayer. Prior to lamination the individual webs may be surface treated to improve the bonding, a non-limiting example of a surface treatment is corona treating. A primary film or web may be laminated on its upper surface, its lower surface, or both its upper and lower surfaces with a secondary web. A secondary web and a tertiary web could be laminated to the primary web; wherein the secondary and tertiary webs differ in chemical composition.

More specifically, an embodiment of this invention is the extrusion lamination or adhesive lamination of the inventive multilayer film comprising a core layer comprising at least one random polypropylene copolymer and at least one adjacent skin or intermediate layer, to a secondary substrate. Non-limiting examples of secondary substrates include; polyamide film, polyester film and polypropylene film. Secondary substrates may also contain a vapor deposited barrier layer; for example a thin silicon oxide (SiOₓ) or aluminum oxide (AlOₓ) layer. Secondary substrates may also be multilayer, containing three, five, seven, nine, eleven or more layers.

Embodiments of this invention also include the extrusion or adhesive lamination of the inventive multilayer film to a secondary substrate that is microlayered; wherein the term “microlayered” refers to films containing hundreds to thousands of individual thermoplastic layers. As an example, Muller et al. in the Journal of Applied Polymer Science, volume 78, pages 816-828, 2000, discloses films containing 256, 1024 and 4096 microlayers. A non-limiting process to produce microlayered cast films is the use of a layer multiplying feedblock as described in by Schrenk in U.S. Pat. Nos. 3,884,606, 5,094,788 and 5094793.

Embodiments of this invention include articles of manufacture produced wherein at least one component is formed from the inventive multilayer film comprised of a core layer comprising at least one random polypropylene copolymer and at least one skin or intermediate layer adjacent to said core layer; wherein the inventive multilayer film component has improved machine direction tear, as determined by ASTM D-1922, that is at least about 30% higher compared with a core layer comprising at least one impact polypropylene copolymer; wherein the inventive multilayer film component has at least about 10% lower film haze, as determined by ASTM D-1003, compared with a core layer comprising at least one impact polypropylene copolymer, and; wherein the inventive multilayer film component has an improved tear ratio, as determined by ASTM D-1922, of at least about 30% higher compared with a core layer comprising at least one impact polypropylene copolymer. Non-limiting examples of articles of manufacture include packages, pouches and heavy-duty sacks, as well as articles produced by extrusion lamination, adhesive lamination and extrusion coating.

Embodiments of this invention include a process to manufacture the inventive multilayer film. In the first process step a coextrusion line is selected, comprising two extruders and a die equipped to combine two thermoplastic melt streams into a continuous coextruded film. Coextrusion lines with two, three, five, seven and eleven extruders equipped with dies to produce blown or cast films are well known to those skilled in the art. In the second step, a core extruder feed is prepared by tumble blending at least one random polypropylene copolymer and optional additives and adjuvants and loading the core extruder feed into the core extruder feed hopper. In the third step, a skin extruder feed is prepared by tumble blending at least one ethylene interpolymer and optional additives and adjuvants and loading the skin extruder feed into the skin extruder feed hopper. In the optional variant of the third step, a three extruder coextrusion line is selected, and the skin extruder feed is added to the inner skin extruder feed hopper and the outer skin extruder feed hopper; or optionally, chemically distinct skin feeds are prepared by tumble blending at least one ethylene interpolymer and optional additives and adjuvants and loading the chemically distinct skin feeds into the inner skin extruder feed hopper and the outer skin extruder feed hopper. It is well known to those experienced in the art that chemically distinct compositions in the inner and outer skin layers are advantageous in many applications; in other words, if one wishes the physical properties of the inner and outer skins to differ, non-limiting examples of such physical properties include, coefficient of friction, blocking or anti-blocking characteristics, seal initiation temperature or bond strength to a specific secondary substrate. In the fourth step the core extruder feed and the skin extruder feed are extruded and converted to form a three layer film comprising; a core layer, and an inner layer and an outer layer; wherein the inner and the outer layer are adjacent to said core layer. In the optional three extruder version of the fourth step, a three layer film is produced comprising a core layer, an inner layer and an outer layer; wherein the inner and the outer layer are adjacent to the core layer; optionally, the inner and the outer skin layers may differ in chemical composition. This four step process produces a three layer coextruded film with improved machine direction tear, as determined by ASTM D-1922, that is about 30% higher compared with a core layer comprising at least one impact polypropylene copolymer. This four step process produces a three layer coextruded film with at least about 10% lower film haze, as determined by ASTM D-1003, compared with a core layer comprising at least one impact polypropylene copolymer. This four step process produces a three layer coextruded film that has an improved tear ratio, as determined by ASTM D-1922, of at least about 30% higher compared with a core layer comprising at least one impact polypropylene copolymer.

The multilayer films of this invention may optionally include, depending on its intended use, additives and adjuvants, which can include, without limitation, anti-blocking agents, antioxidants, slip agents, processing aids, anti-static additives, colorants, dyes, filler materials, heat stabilizers, light stabilizers, light absorbers, lubricants, pigments, plasticizers, and combinations thereof.

Suitable anti-blocking agents, slip agents and lubricants include without limitation silicone oils, liquid paraffin, synthetic paraffin, mineral oils, petrolatum, petroleum wax, polyethylene wax, hydrogenated polybutene, higher fatty acids and the metal salts thereof, linear fatty alcohols, glycerine, sorbitol, propylene glycol, fatty acid esters of monohydroxy or polyhydroxy alcohols, hydrogenated castor oil, beeswax, acetylated monoglyceride, hydrogenated sperm oil, ethylenebis fatty acid esters, and higher fatty amides. Suitable lubricants include, but are not limited to, ester waxes such as the glycerol types, the polymeric complex esters, the oxidized polyethylene type ester waxes and the like, metallic stearates such as barium, calcium, magnesium, zinc and aluminum stearate, salts of 12-hydroxystearic acid, amides of 12-hydroxystearic acid, stearic acid esters of polyethylene glycols, castor oil, ethylene-bis-stearamide, ethylene-bis-cocamide, ethylene-bis-lauramide, pentaerythritol adipate stearate and combinations thereof in an amount of from about 0.1 wt % to about 2 wt % of the multilayer film composition.

Suitable antioxidants include without limitation Vitamin E, citric acid, ascorbic acid, ascorbyl palmitrate, butylated phenolic antioxidants, tert-butylhydroquinone (TBHQ) and propyl gallate (PG), butylated hydroxyanisole (BHA), butylated hydroxytoluene (BHT), and hindered phenolics such as IRGANOX® 1010 and IRGANOX 1076 available from Ciba Specialty Chemicals Corp., Tarrytown, N.Y.

Suitable heat stabilizers include, without limitation, phosphite or phosphonite stabilizers and hindered phenols, non-limiting examples being the IRGANOX® and IRGAFOS® stabilizers and antioxidants available from Ciba Specialty Chemicals. When used, the heat stabilizers are included in an amount of about 0.1 wt % to about 2 wt % of the multilayer film compositions.

Non-limiting examples of suitable polymer processing aids include fluoroelastomers such as poly(vinylidene fluoride-co-hexafluoropropylene), poly(vinylidene fluoride-co-hexafluoropropylene-co-tetrafluoroethylene), poly(vinylidene fluoride-co-tetrafluoroethylene-co-perfluoro(methyl vinyl ether)), poly(tetrafluoroethylene-co-perfluoro(methyl vinyl ether), polytetrafluoroethylene-co-ethylene-co-perfluoro(methyl vinyl ether) and blends of fluoroelastomers with other lubricants such as polyethylene glycol.

Suitable anti-static agents include, without limitation, glycerine fatty acid, esters, sorbitan fatty acid esters, propylene glycol fatty acid esters, stearyl citrate, pentaerythritol fatty acid esters, polyglycerine fatty acid esters, and polyoxethylene glycerine fatty acid esters in an amount of from about 0.01 wt % to about 2 wt % of the multilayer film compositions.

Suitable colorants, dyes and pigments are those that do not adversely impact the desirable physical properties of the multilayer film including, without limitation, white or any colored pigment. In embodiments of this invention, suitable white pigments contain titanium oxide, zinc oxide, magnesium oxide, cadmium oxide, zinc chloride, calcium carbonate, magnesium carbonate, kaolin clay and combinations thereof in an amount of about 0.1 wt % to about 20 wt % of the multilayer film. In embodiments of this invention, the colored pigment can include carbon black, phthalocyanine blue, Congo red, titanium yellow or any other colored pigment typically used in the industry in an amount of about 0.1 wt % to about 20 wt % of the multilayer film. In embodiments of this invention, the colorants, dyes and pigments include inorganic pigments including, without limitation, titanium dioxide, iron oxide, zinc chromate, cadmium sulfides, chromium oxides and sodium aluminum silicate complexes. In embodiments of this invention, the colorants, dyes and pigments include organic type pigments, which include without limitation, azo and diazo pigments, carbon black, phthalocyanines, quinacridone pigments, perylene pigments, isoindolinone, anthraquinones, thioindigo and solvent dyes.

Suitable fillers are those that do not adversely impact, and in some cases enhance, the desirable physical properties of the multilayer film. Suitable fillers, include, without limitation, talc, silica, alumina, calcium carbonate in ground and precipitated form, barium sulfate, talc, metallic powder, glass spheres, barium stearate, calcium stearate, aluminum oxide, aluminum hydroxide, glass, clays such as kaolin and montmorolites, mica, silica, alumina, metallic powder, glass spheres, titanium dioxide, diatomaceous earth, calcium stearate, aluminum oxide, aluminum hydroxide, and fiberglass, and combinations thereof can be incorporated into the polymer composition in order to reduce cost or to add desired properties to the multilayer film. The amount of filler is desirably less than about 20% of the total weight of the multilayer film as long as this amount does not alter the properties of the multilayer film. Suitable fillers also include nanofillers. Nanofillers may be: plate-like in shape where the plate thickness is less than about 100 nm; tube-like in shape where the tube diameter is less than about 100 nm, and; nanoparticles where all dimensions are less than about 100 nm. Non-limiting examples of nanofillers include: natural or synthetic nanoclays, i.e., phyllosilicates such as montmorillonite, bentonite or kaolinite; nano-oxides such as titanium dioxide (anastase) or aluminum oxide; carbon nanotubes, and; metallic nanoparticles such as zinc or silver.

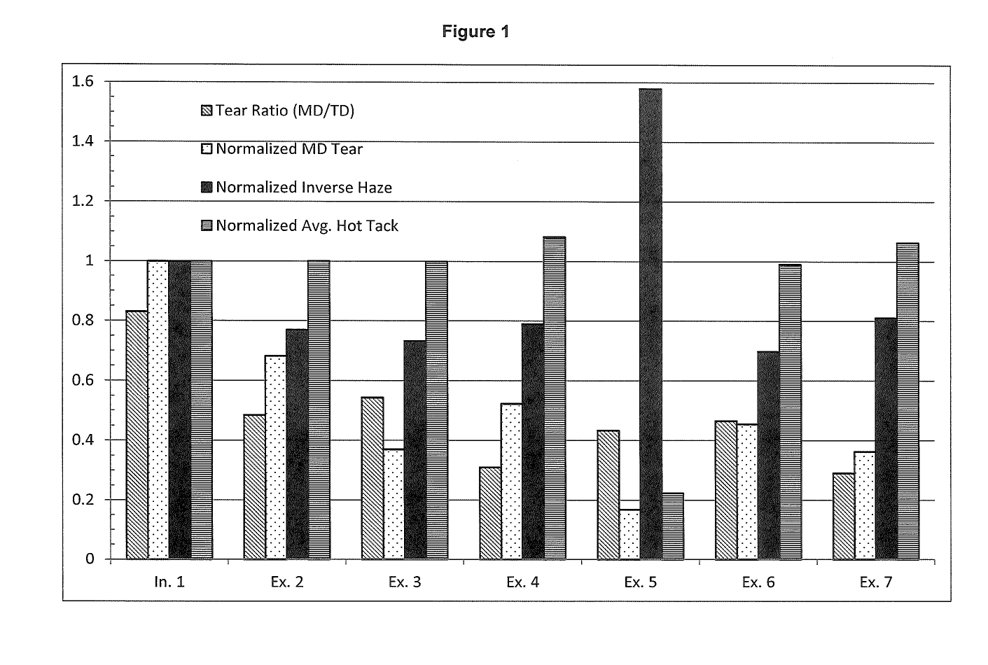

For a better understanding of some embodiments of the present invention, FIGS. 1, 2 and 3 are presented; however, these figures are intended purely as examples and are not to be construed as limiting.

The present invention will further be described by reference to the following examples. The following examples are merely illustrative of the invention and are not intended to be limiting. Unless otherwise indicated, all percentages are by weight unless otherwise specified.

### Raw Materials

Three layer coextruded films were produced from the polyolefins shown in Table 1. FPs016-C, hereafter sLL-1, is a linear low density polyethylene available from NOVA Chemicals Inc. produced with a single site catalyst in a solution polymerization process. FPs117-D, hereafter sLL-2, is a linear low density polyethylene available from NOVA Chemicals Inc. produced with a single site catalyst in a solution polymerization process. sLL-1 and sLL-2 are copolymers of ethylene and 1-octene which differ in density and melt index. LF-Y320-D, hereafter LD, is a low density polyethylene available from NOVA Chemicals Inc. produced in a high pressure process using a peroxide catalyst. TR3020UC, hereafter RCP, is a random polypropylene available from Braskem; additional physical properties are shown in Table 2. TI4015F2, hereafter ICP, is an impact polypropylene available from Braskem; additional physical properties are shown in Table 2. Both RCP and ICP meet the requirements for olefin polymers as defined in 21 CFR, section 177.1520 issued by the Food and Drugs Administration.

### Coextruded Films

A three layer coextruded blown film structure may be described as A/B/C; where B represents a chemically distinct layer of thermoplastic, typically called the “core layer”, sandwiched between two chemically distinct thermoplastic “skin layers” denoted by A and C. In many multilayer films, one (or both) of the skin layers are made from a resin which provides good seal strength and is typically referred to as a sealant layer. In the case of a three layer coextruded film with the A/B/A structure, the two skin layers have the same chemical composition.

### Blown Film Extrusion

Three layer coextruded blown films were fabricated using a Brampton 3-layer blown film line; this line was equipped with three extruders such that A/B/C coextruded film structures can be produced. All three extruders had a consistent barrel diameter (D) of 1.75 inch (4.45 cm) and barrel length (L); extruder barrel to length ratio was 30 (L/D). The 3-layer blown film die was a pancake design and the exit lip diameter was 4 inch (10.2 cm). A Saturn I air ring was used to quench the extrudate. The following operating conditions were used to generate three layer blown film samples: Blow-Up-Ratio (BUR) of 2.5:1; 4 inch (10.2 cm) die; 35 mil (0.089 cm) die gap; frost line height was 28 inch (71 cm) and 100 lb/hr (45.4 kg/hr) output rate. The temperature set points on the 3-layer blown film line are shown in Table 3. The temperature set points on extruder B (polypropylene extruder) were higher than the temperature set points on extruder A and C (polyethylene extruders). The column labeled “Actual or Recorded” temperature reflects the temperature of the molten thermoplastics as measured by thermocouples. The temperature range in the “Actual or Recorded” column documents the minimum temperature and the maximum temperature observed during the coextrusion of the seven film samples, i.e., Inventive 1, and Examples 2 through 7. The same thermoplastic, or thermoplastic blend, was consistently run in both A and C extruders. In other words, using conventional coextrusion nomenclature the S-layer films produced had the following structure: A/B/A. Hereafter, these operating conditions will be referred to as “standard operating conditions”.

Measurement of Hot tack Strength

The hot tack strength of film samples were measured using a J&B Hot Tack Tester; hereafter, this test method will be referred to as the “J&B Hot Tack Test”. The J&B Hot Tack Tester is commercially available from Jbi Hot Tack, Geloeslaan 30, B-3630 Maamechelen, Belgium. In the hot tack test the strength of a polyolefin to polyolefin seal is measured immediately after heat sealing two films together, i.e., when the polyolefin is in a semi-molten state. This test simulates heat sealing on automatic packaging machines, e.g., vertical or horizontal form, fill and seal equipment. The following parameters were used in the J&B Hot Tack Test: film specimen width, 1 inch (25.4 mm); film sealing time, 0.5 second; film sealing pressure, 0.27 N/mm²; delay time, 0.5 second; film peel speed, 7.9 in/second (200 mm/second); temperature range, 203° F. to 293° F. (95° C. to 145° C.); temperature increments, 9° F. (5° C.); and five film samples tested at each temperature increment to calculate an average value.

### Measurement of Heat Seal Strength

The heat seal strength of film samples were measured using a conventional Instron Tensile Tester; hereafter, this test method will be referred to as the “Heat Seal Strength Test”. In this test, two films are sealed over a range of temperatures. Seals were then aged at least 24 hours at 73° F. (23° C.) and then subjected to tensile testing. The following parameters were used in the Heat Seal Strength Test: film specimen width, 1 inch (25.4 mm); film sealing time, 0.5 second; film sealing pressure, 0.27 N/mm²; temperature range, 212° F. to 302° F. (100° C. to 150° C.) and temperature increment, 9° F. (5° C.). After aging, seal strength was determined using the following tensile parameters: pull (crosshead) speed, 1640 ft/minute (500 m/minute); direction of pull, 90° to seal; full scale load, 11 lb (5 kg); and 5 samples of film were tested at each temperature increment.

The present invention will further be described by reference to the following examples. The following examples are merely illustrative of the invention and are not intended to be limiting. Unless otherwise indicated, all percentages are by weight and Portland cement is used unless otherwise specified.

### EXAMPLES

### Inventive 1

Coextruded film Inventive 1, of structure A/B/A, was produced on the Brampton 3-layer blown film line using the standard operating conditions. In Inventive 1: layer B, the core layer, contained RCP (Braskem TR3020UC); and layer A, the two skin layers, contained sLL-1 (FPs016-C). The two A layers also contained 2500 ppm talc, typically called a film antiblock additive, and 600 ppm erucamide, typically called a film slip additive. The total thickness of coextruded film Inventive 1 was 2.0 mil (50 μm) and the A/B/A layer ratios were 20/60/20, respectively; more specifically, A layers were 0.4 mil (10 μm) and the B layer was 1.2 mil (30 μm).

### Example 2

Coextruded film Example 2, of structure A/B/A, was produced on the Brampton 3-layer blown film line using the standard operating conditions. In Example 2: layer B, was a binary blend, made of 85 wt % RCP (Braskem TR3020UC) and 15 wt % ICP (TI4015F2); and the two A layers contained sLL-1 (FPs016-C). The two A layers also contained 2500 ppm antiblock and 600 ppm slip. The total thickness of coextruded film Example 2 was 2.0 mil (50 μm) and the A/B/A layer ratios were 20/60/20.

### Example 3

Coextruded film Example 3, differed from Example 2 in one respect: layer ratio. Specifically, in Example 3 the A/B/A layer ratio was 15/70/15; in contrast with 20/60/20 in Example 2. As a result, in Example 3 the A layers were thinner 0.3 mil (7.6 μm) and the B layer was thicker 1.4 mil (34.8 μm); in contrast, in Example 2, the A layers were 0.4 mil (10 μm) and the B layer was 1.2 mil (30 μm).

### Example 4

Coextruded film Example 4, of structure A/B/A, was produced on the Brampton 3-layer blown film line using the standard operating conditions. In Example 4: layer B, was a binary blend, made of 85 wt % RCP (Braskem TR3020UC) and 15 wt % ICP (TI4015F2); both A layers contained a binary blend, made of 85 wt % sLL-1 (FPs016-C) and 15 wt % LD (LF-Y320-D). The two A layers also contained 2500 ppm antiblock and 600 ppm slip. The total thickness of coextruded film Example 4 was 2.0 mil (50 μm) and the A/B/A layer ratios were 20/60/20.

### Example 5

Example 5 was produced on the Brampton 3-layer blown film line using the standard operating conditions; however, RCP (TR3020UC) was run in all three extruders. As a result, in film Example 5, all layers of the A/B/A structure were composed of RCP. The total thickness of coextruded film Example 5 was 2.0 mil (50 μm) and the A/B/A layer ratios were 20/60/20.

### Example 6

Coextruded film Example 6, of structure A/B/A, was produced on the Brampton 3-layer blown film line using the standard operating conditions. In Example 6: layer B, was a binary blend, made of 85 wt % Braskem RCP (TR3020UC) and 15 wt % ICP (TI4015F2); and the two A layers contained sLL-2 (FPs117-D). The two A layers also contained 1000 ppm slip and 2500 ppm antiblock. The total thickness of coextruded film Example 6 was 2.0 mil (50 μm) and the A/B/A layer ratios were 20/60/20.

### Example 7

Coextruded film Example 7, differed from Example 6 in one respect; 15 wt % of LD (LF-Y320-D) was added to the A layers. More specifically, in film Example 7: both A layers contained a binary blend of 85 wt % sLL-1 (FPs117-D) and 15 wt % LD; and the core layer contained a binary blend of 85 wt % Braskem RCP (TR3020UC) and 15 wt % ICP (TI4015F2). A layers contained 925 ppm slip and 2700 ppm antiblock. The total thickness of coextruded film Example 7 was 2.0 mil (50 μm) and the A/B/A layer ratios were 20/60/20.

The physical properties of the coextruded films are summarized in Tables 4 and 5. In Table 4, the structure of the coextruded film sample Inventive 1 was abbreviated to: sLL-1/RCP; which represents the 3-layer film sLL-1/RCP/sLL-1. Similarly, in Table 5, the structure of the coextruded film sample Example 7 was abbreviated to: sLL-2+LD/RCP+ICP; which represents the 3-layer film sLL-2+LD/RCP+ICP/sLL-2+LD; wherein a salt and pepper binary blend of sLL-1 and LD was added to both A and C extruders, and a salt and pepper binary blend of RCP and ICP was added to extruder B. With the exception of Example 3, the A/B/A layer ratio was consistently 20/60/20. In Tables 4 and 5 one can compare tear strength, haze, clarity, gloss, dart drop impact, puncture resistance and the tensile properties of the seven coextruded films.

Table 6 illustrates the surprisingly improved performance of the inventive coextruded film sample Inventive 1, relative to comparative films. Specifically, Inventive 1, comprised of a random polypropylene copolymer (RCP) in the core and an inner and outer skin layer comprised of an ethylene interpolymer has improved MD tear, improved tear ratio and improved haze; compared to films where the core layer contains an impact polypropylene copolymer (ICP), i.e., Examples 2, 3, 4, 6 and 7. More specifically, at constant layer ratio thickness, the MD tear of Inventive 1 (sLL-1/RCP) was improved 47% relative to Example 2 (sLL-1/RCP(85%)+ICP(15%)) and improved 175% relative to Example 7 (sLL-2(85%)+LD(15%)/RCP(85%)+ICP(15%)); the tear ratio of Inventive 1 was improved 72% relative to Example 2 and improved 185% relative to Example 7; the haze of Inventive 1 was improved −21% relative to Example 4 (sLL-1(85%)+LD(15%)/RCP(85%)+ICP(15%))) and improved −30% relative to Example 6 (sLL-2/RCP(85%)+ICP(15%)). Lower haze is desirable in blown film applications.

Comparative Example 5 was a 3-layer coextruded film; wherein all three layers contained the random polypropylene copolymer, i.e., RCP/RCP/RCP. The physical properties of comparative Example 5 are summarized in Tables 5 and 6. Relative to Inventive 1, Example 5 has inferior MD tear, tear ratio and hot tack; although Example 5 has improved (lower) haze.

Hot tack data for coextruded film samples Inventive 1 through 7 are shown in Table 7. Example 5 (RCP/RCP/RCP) has significantly lower hot tack, relative to the films where the skin layers are comprised of an ethylene interpolymer, or ethylene interpolymer blend. The average hot tack value of each coextruded film is summarized in Table 8. The average hot tack was calculated by averaging selected hot tack values from Table 7; specifically, the averaged hot tack was the average value between the minimum and the maximum temperature shown in Table 8. The term “average hot tack” is equivalent to the term “maximum hot tack”, i.e., the initial low temperature region of the hot tack curve was not included in the hot tack average.

Selected physical properties of the 3-layer coex films are compared graphically in FIG. 1. The improved performance of inventive coextruded film Inventive 1 is apparent, relative to comparative coextruded film Examples 2 through 7. Inventive film Inventive 1, comprised of a random polypropylene copolymer (RCP) in the core and an inner and outer skin layer comprised of an ethylene interpolymer has improved MD tear, improved tear ratio and improved haze, relative to films where the core layer contains an impact polypropylene copolymer (ICP), i.e., Examples 2, 3, 4, 6 and 7; in addition, Inventive 1 has improved hot tack relative to Example 5 (RCP/RCP/RCP).

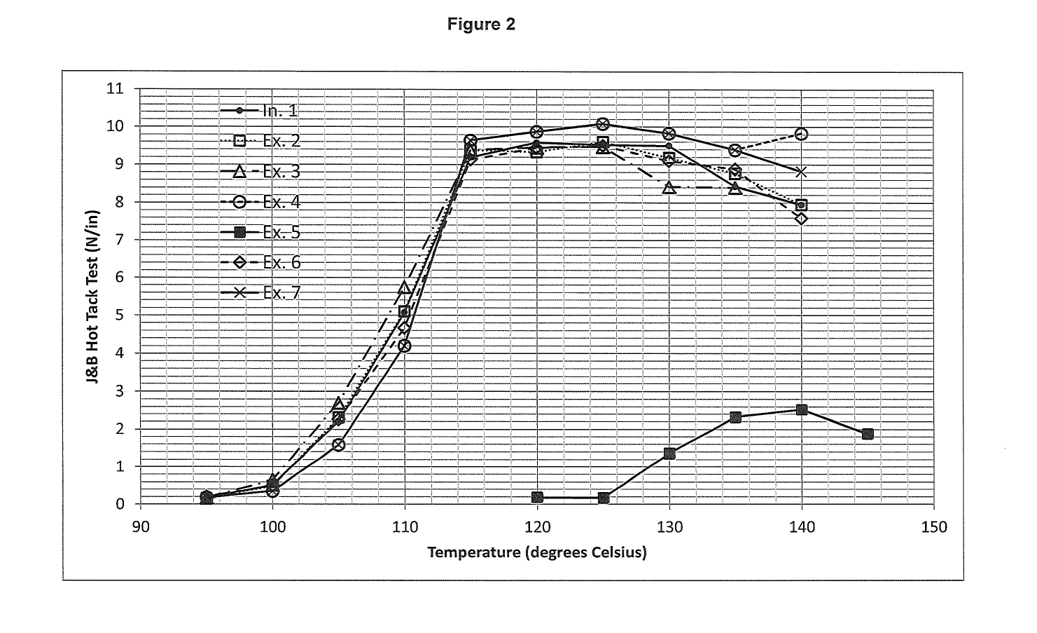

The hot tack curves of the seven coextruded films are compared in FIG. 2. The inferior hot tack of Example 5 (RCP/RCP/RCP) is evident.

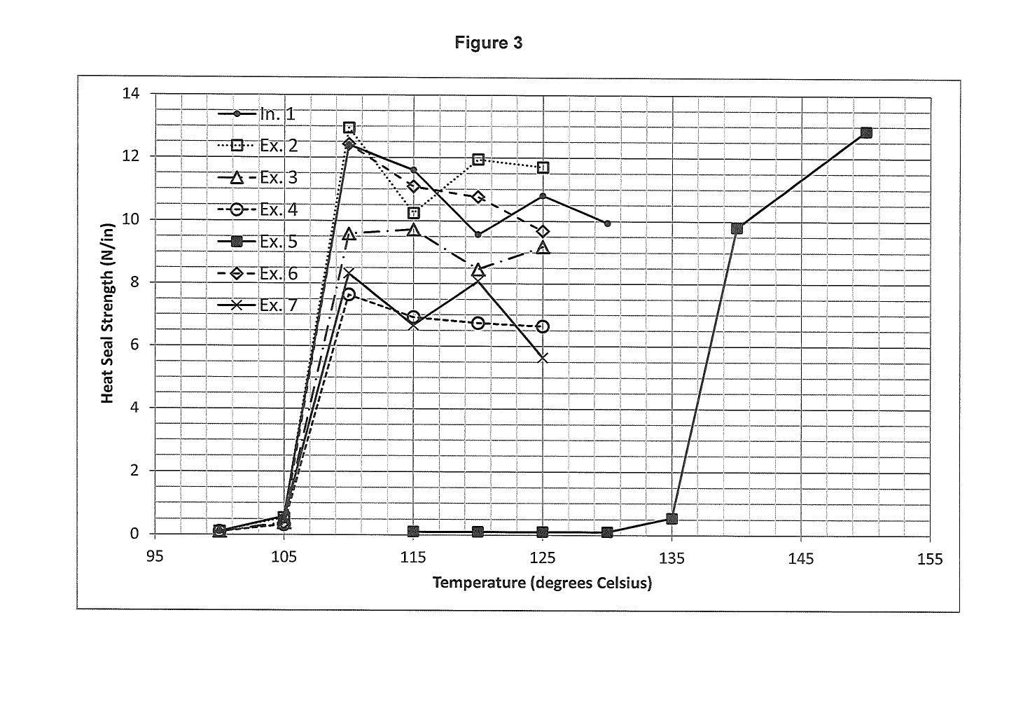

The heat seal curves of the seven coextruded films are compared in FIG. 3. The higher melting point and higher seal initiation temperature of the random polypropylene copolymer is clearly evident, i.e., Example 5 (RCP/RCP/RCP).

TABLE 1
Melt index (ASTM D-1238) and density (ASTM D-1505)
of the ethylene polymers converted into film

| | | Melt Index | Melt Index | |
|---|---|---|---|---|
| | | (g/10 min | (g/10 min | |
| Ethylene | Symbol or | at 190° C. | at 230° C. | Density |
| Polymer | Code | and 2.16 kg) | and 2.16 kg) | (g/cc) |
| FPs016-C | sLL-1 | 0.65 | n/a | 0.916 |
| FPs117-D | sLL-2 | 1.0 | n/a | 0.917 |
| LF-Y320-D | LD | 0.25 | n/a | 0.922 |
| TR3020UC | RCP | n/a | 1.6 | 0.895 |
| TI4015F2 | ICP | n/a | 2.0 | 0.895 |

TABLE 2
TR3020UC (RCP) and TI4015F2 (ICP) technical specifications

| Poly- | Injection Molded | | | ASTM |
|---|---|---|---|---|
| propylene | Plaque Properties | Units | Value | Method |
| TR3020UC | Tensile Strength at | Psi | 4,400 | D-638 |
| (RCP) | Yield at 2 in/min | MPa | 30 | |
| | (50 mm/min) | | | |
| | Elongation at Yield | % | 13 | D-638 |
| | at 2 in/min | | | |
| | (50 mm/min) | | | |
| | Flexural Modulus 1% | Psi | 155,000 | D-790A |
| | Secant at 0.05 in/min | MPa | 1,069 | |
| | (1.3 mm/min) | | | |
| | Notched IZOD impact | Ft-lbs/in | 2.5 | D-256A |
| | strength at 23° C. | J/m | 133 | |
| | Haze, 50 mil disc | % | 5 | D-1003 |
| | (0.13 mm) | | | |
| TI4015F2 | Tensile Strength at | Psi | 3,800 | D-638 |
| (ICP) | Yield at 2 in/min | MPa | 26 | |
| | (50 mm/min) | | | |
| | Elongation at Yield | % | 17 | D-638 |
| | at 2 in/min | | | |
| | (50 mm/min) | | | |
| | Flexural Modulus 1% | Psi | 180,000 | D-790A |
| | secant at 0.05 in/min | MPa | 1,241 | |
| | (1.3 mm/min) | | | |
| | Notched IZOD impact | | No | D-256A |
| | strength at 23° C. | | Break | |
| | Gardner Impact | ft-lbs | 21 | D-5420G |
| | Strength | | | |
| | at −29° C. | | | |

TABLE 3
Blown film extrusion temperature set points and
minimum and maximum temperatures recorded during
the extrusion of Examples 1 through 7

| | | Extruders A and C | | Extruder B | |
|---|---|---|---|---|---|
| | | | Inventive 1, | | Inventive 1, |
| | | | Example 2-7 | | Examples 2-7 |
| | | Set | Actual or | Set | Actual or |
| Location | Unit | Point | Recorded | Point | Recorded |
| Throat | ° F. | 75 | 72-78 | 75 | 75-77 |
| | ° C. | 24 | 22-26 | 24 | 24-25 |
| Barrel 1 | ° F. | 370 | 368-371 | 420 | 416-422 |
| | ° C. | 188 | 187-188 | 216 | 213-217 |
| Barrel 2 | ° F. | 400 | 399-403 | 470 | 466-472 |
| | ° C. | 204 | 204-206 | 243 | 241-244 |
| Barrel 3 | ° F. | 400 | 396-400 | 450 | 448-452 |
| | ° C. | 204 | 202-204 | 232 | 231-233 |
| Barrel 4 | ° F. | 400 | 397-400 | 450 | 449-451 |
| | ° C. | 204 | 203-204 | 232 | 232-233 |
| Screen | ° F. | 400 | 397-402 | 430 | 428-431 |
| | ° C. | 204 | 203-206 | 221 | 220-222 |
| Adapter | ° F. | 400 | 397-401 | 440 | 439-440 |
| | ° C. | 204 | 203-205 | 227 | 226-227 |
| Die | ° F. | 440 | 438-442 | 440 | 438-440 |
| | ° C. | 227 | 226-228 | 227 | 226-227 |
| Melt | ° F. | | 414-428 | — | 459-465 |
| Temperature | ° C. | | 212-220 | — | 237-241 |

TABLE 4
Film physical data for Inventive 1 through Example 4

| | | | Example 2 | Example 3 | Example 4 |
|---|---|---|---|---|---|
| | | Invent. 1 | sLL-1/ | sLL-1/ | sLL-1 + |
| | | sLL-1/ | RCP + | RCP + | LD/RCP + |
| Physical Test | Unit | RCP | ICP | ICP | ICP |
| Layer Ratio | | 20/60/20 | 20/60/20 | 15/70/15 | 20/60/20 |
| Tear MD | g/mil | 44 | 30 | 16.3 | 23 |
| Tear TD | g/mil | 53 | 62 | 30 | 74 |
| Tear Balance | — | 0.83 | 0.48 | 0.54 | 0.31 |
| (Tear MD/ | | | | | |
| Tear TD) | | | | | |
| Haze | % | 6.0 | 7.8 | 8.2 | 7.6 |
| Inverse Haze | %⁻¹ | 0.17 | 0.13 | 0.12 | 0.13 |
| Clarity | % | 96.1 | 95.8 | 95.6 | 94.5 |
| Gloss | — | 80 | 77 | 77 | 75 |
| Dart Drop | g/mil | 100 | 147 | 108 | 115 |
| Puncture | J/mm | 41 | 42 | 42 | 41 |
| Resistance | | | | | |
| 1% Secant MD | MPa | 602 | 638 | 718 | 631 |
| 2% Secand MD | MPa | 487 | 512 | 574 | 509 |
| 1% Secant TD | MPa | 619 | 615 | 666 | 597 |
| 2% Secant TD | MPa | 498 | 496 | 538 | 479 |
| Tensile Break | MPa | 56.6 | 57.5 | 59.9 | 53.9 |
| MD | | | | | |
| Tensile | % | 649 | 646 | 676 | 631 |
| Elongation MD | | | | | |
| Tensile Yield MD | MPa | 23.3 | 23.3 | 25.9 | 24 |
| Tensile Break TD | MPa | 45.6 | 44.7 | 41.6 | 44.9 |
| Tensile | % | 679 | 681 | 664 | 713 |
| Elongation TD | | | | | |
| Tensile Yield TD | MPa | 22.6 | 22.3 | 24.6 | 21.9 |

TABLE 5
Film physical data for Example 5 through Example 7

| | | | Example 6 | Example 7 |
|---|---|---|---|---|
| | | Example 5 | sLL-2/ | sLL-2 + LD/ |
| Physical Test | Unit | RCP/RCP | RCP + ICP | RCP + ICP |
| Layer Ratio | — | 20/60/20 | 20/60/20 | 20/60/20 |
| Tear MD | g/mil | 7.36 | 20 | 16 |
| Tear TD | g/mil | 17 | 43 | 55 |
| Tear Balance | — | 0.43 | 0.47 | 0.29 |
| (Tear MD/Tear TD) | | | | |
| Haze | % | 3.8 | 8.6 | 7.4 |
| Inverse Haze | %⁻¹ | 0.26 | 0.12 | 0.14 |
| Clarity | % | 96.7 | 95.7 | 94.7 |
| Gloss | — | 80 | 77 | 78 |
| Dart Drop | g/mil | 23 | 100 | 98 |
| Puncture Resistance | J/mm | 41 | 40 | 40 |
| 1% Secant MD | MPa | 924 | 624 | 650 |
| 2% Secant MD | MPa | 742 | 504 | 526 |
| 1% Secant TD | MPa | 917 | 594 | 608 |
| 2% Secant TD | MPa | 731 | 479 | 489 |
| Tensile Break MD | MPa | 46.3 | 50.5 | 54.6 |
| Tensile Elongation MD | % | 616 | 683 | 718 |
| Tensile Yield MD | MPa | 33 | 22.5 | 23 |
| Tensile Break TD | MPa | 29.3 | 44.2 | 46.9 |
| Tensile Elongation TD | % | 568 | 727 | 752 |
| Tensile Yield TD | MPa | 31.7 | 21.7 | 22.4 |

TABLE 6
Improved film MD tear and improved film haze of a film containing a
random polypropylene copolymer (RCP), relative to a similar film containing
an impact polypropylene copolymer (ICP); higher MD tear is advantageous
and lower haze is advantageous

| | | | | Tear | | |
|---|---|---|---|---|---|---|
| | MD | MD Tear | | Ratio | | Haze |
| | Tear | Improvement^{a} | Tear | Improvement^{b} | Haze | Improvement^{c} |
| Sample | (g/mil) | (%) | Ratio | (%) | (%) | (%) |
| Inventive 1 | 44 | 0% | 0.83 | 0% | 6 | 0% |
| sLL-1/RCP | | | | | | |
| Example 2 | 30 | 47% | 0.48 | 72% | 7.8 | −23% |
| sLL-1/RCP + ICP | | | | | | |
| Example 3 | 16.3 | 170% | 0.54 | 53% | 8.2 | −27% |
| sLL-1/RCP + ICP | | | | | | |
| Example 4 | 23 | 91% | 0.31 | 167% | 7.6 | −21% |
| sLL-1 + LD/RCP + ICP | | | | | | |
| Example 5 | 7.36 | 498% | 0.43 | 92% | 3.8 | 58% |
| RCP/RCP | | | | | | |
| Example 6 | 20 | 120% | 0.47 | 78% | 8.6 | −30% |
| sLL-2/RCP + ICP | | | | | | |
| Example 7 | 16 | 175% | 0.29 | 185% | 7.4 | −19% |
| sLL-2 + LD/RCP + ICP | | | | | | |

^{a}((Inventive 1 MD Tear)-(Example i MD Tear))/(Example i MD Tear); where i = 1 to 7.
^{b}((Inventive 1 Tear Ratio)-(Example i Tear Ratio))/(Example i Tear Ratio); where i = 1 to 7.
^{c}((Inventive 1 Haze)-(Example i Haze))/(Example i Haze); where i = 1 to 7. Lower haze is more desirable, i.e., improved.

TABLE 7
J&B Hot Tack Test results for film Inventive 1 through Example 7

| | J&B Hot Tack (N/in) | | | | | | |
|---|---|---|---|---|---|---|---|
| | In. 1 | | | | | | |
| | sLL-1/ | Ex. 2 | Ex. 3 | Ex. 4 | Ex. 5 | Ex. 6 | Ex. 7 |
| | RCP | sLL-1/ | sLL-1/ | sLL-1 + LD/ | RCP/ | sLL-2/ | sLL-2 + LD/ |
| Temp. | 20/60/ | RCP + ICP | RCP + ICP | RCP + ICP | RCP | RCP + ICP | RCP + ICP |
| (° C.) | 20 | 20/60/20 | 15/70/15 | 20/60/20 | 20/60/20 | 20/60/20 | 20/60/20 |
| 95 | 0.16 | 0.14 | 0.17 | 0.18 | — | 0.20 | 0.18 |
| 100 | 0.51 | 0.49 | 0.65 | 0.35 | — | 0.50 | 0.35 |
| 105 | 2.21 | 2.31 | 2.7 | 1.58 | — | 2.26 | 1.58 |
| 110 | 5.07 | 5.10 | 5.74 | 4.20 | — | 4.67 | 4.20 |
| 115 | 9.19 | 9.38 | 9.38 | 9.64 | — | 9.13 | 9.64 |
| 120 | 9.58 | 9.33 | 9.45 | 9.87 | 0.18 | 9.44 | 9.87 |
| 125 | 9.52 | 9.6 | 9.47 | 10.08 | 0.17 | 9.50 | 10.08 |
| 130 | 9.50 | 9.18 | 8.42 | 9.83 | 1.36 | 9.10 | 9.83 |
| 135 | 8.43 | 8.77 | 8.40 | 9.39 | 2.32 | 8.88 | 9.39 |
| 140 | 7.95 | 7.95 | — | 9.83 | 2.52 | 7.59 | 8.82 |
| 145 | — | — | — | — | 1.88 | — | — |

TABLE 8
J&B Average Hot Tack, averages were calculated
over the temperature range indicated

| | | Average | Temperature Range | |
|---|---|---|---|---|
| | | J&B Hot | Min. | Max. |
| Sample | Structure | Tack (N/in) | (° C.) | (° C.) |
| In. 1 | sLL-1/RCP | 9.03 ± 0.68 | 115 | 140 |
| | 20/60/20 | | | |
| Ex. 2 | sLL-1/RCP + ICP | 9.04 ± 0.6 | 115 | 140 |
| | 20/60/20 | | | |
| Ex. 3 | sLL-1/RCP + ICP | 9.02 ± 0.56 | 115 | 135 |
| | 15/70/15 | | | |
| Ex. 4 | sLL-1 + LD/ | 9.77 ± 0.23 | 115 | 140 |
| | RCP + ICP | | | |
| | 20/60/20 | | | |
| Ex. 5 | RCP/RCP | 2.02 ± 0.51 | 130 | 145 |
| | 20/60/20 | | | |
| Ex. 6 | sLL-2/RCP + ICP | 8.94 ± 0.70 | 115 | 140 |
| | 20/60/20 | | | |
| Ex. 7 | sLL-2 + LD/ | 9.61 ± 0.45 | 115 | 140 |
| | RCP + ICP | | | |
| | 20/60/20 | | | |

TABLE 9
Heat Seal Strength Test results for film Inventive 1 through Example 7

| | Heat Seal Strength (N/in) | | | | | | |
|---|---|---|---|---|---|---|---|
| | | Ex. 2 | Ex. 3 | Ex. 4 | Ex. 5 | Ex. 6 | Ex. 7 |
| | In. 1 | sLL-1/ | sLL-1/ | sLL-1 + LD/ | RCP/ | sLL-2/ | sLL-2 + LD/ |
| Temp | sLL-1/RCP | RCP + ICP | RCP + ICP | RCP + ICP | RCP | RCP + ICP | RCP + ICP |
| (° C.) | 20/60/20 | 20/60/20 | 15/70/15 | 20/60/20 | 20/60/20 | 20/60/20 | 20/60/20 |
| 100 | 0.1 | 0.1 | 0.1 | 0.1 | — | — | — |
| 105 | 0.58 | 0.54 | 0.38 | 0.32 | — | 0.36 | 0.5 |
| 110 | 12.4 | 12.94 | 9.58 | 7.64 | — | 12.42 | 8.32 |
| 115 | 11.6 | 10.24 | 9.72 | 6.92 | 0.1 | 11.08 | 6.66 |
| 120 | 9.56 | 11.94 | 8.46 | 6.74 | 0.1 | 10.76 | 8.08 |
| 125 | 10.8 | 11.7 | 9.18 | 6.64 | 0.1 | 9.68 | 5.64 |
| 130 | 9.94 | — | — | — | 0.1 | — | — |
| 135 | — | — | — | — | 0.54 | — | — |
| 140 | — | — | — | — | 9.8 | — | — |
| 150 | — | — | — | — | 12.86 | — | — |

TABLE 10
Average Heat Seal Strength, the average was calculated
over the temperature range indicated

| | | Average | Temperature Range | |
|---|---|---|---|---|
| | | J&B Hot | Min. | Max. |
| Sample | Structure | Tack (N/in) | (° C.) | (° C.) |
| In. 1 | sLL-1/RCP | 10.9 ± 1.2 | 110 | 130 |
| | 20/60/20 | | | |
| Ex. 2 | sLL-1/RCP + ICP | 11.7 ± 1.1 | 110 | 125 |
| | 20/60/20 | | | |
| Ex. 3 | sLL-1/RCP + ICP | 9.24 ± 0.57 | 110 | 125 |
| | 15/70/15 | | | |
| Ex. 4 | sLL-1 + LD/ | 6.99 ± 0.45 | 110 | 125 |
| | RCP + ICP | | | |
| | 20/60/20 | | | |
| Ex. 5 | RCP/RCP | 11.3 ± 2.2 | 140 | 150 |
| | 20/60/20 | | | |
| Ex. 6 | sLL-2/RCP + ICP | 11.0 ± 1.1 | 110 | 125 |
| | 20/60/20 | | | |
| Ex. 7 | sLL-2 + LD/ | 7.18 ± 1.26 | 110 | 125 |
| | RCP + ICP | | | |
| | 20/60/20 | | | |

The present invention has been described with reference to specific details of particular embodiments thereof. It is not intended that such details be regarded as limitations upon the scope of the invention except insofar as and to the extent that they are included in the accompanying claims.

What is claimed is:

1. A coextruded multilayer film comprising: a core layer comprising at least one random polypropylene copolymer; at least one skin or intermediate layer adjacent to said core layer; wherein said coextruded multilayer film has improved machine direction tear, as determined by ASTM D-1922, that is at least about 30% higher compared with a core layer comprising at least one impact polypropylene copolymer.

2. The film according to claim 1, wherein said coextruded multilayer film has at least about 10% lower film haze, as determined by ASTM D-1003, compared with a core layer comprising at least one impact polypropylene copolymer.

3. The film according to claim 1, wherein said coextruded multilayer film has an improved tear ratio, as determined by ASTM D-1922, of at least about 30% higher compared with a core layer comprising at least one impact polypropylene copolymer.

4. The film according to claim 1, wherein said random polypropylene copolymer has a melt index, from about 0.5 g/10 minutes to about 16 g/10 minutes, as determined by ASTM D-1238 at 230° C. and 2.16 kg, and a density from about 0.89 g/cm³ to about 0.91 g/cm³, as determined by ASTM D-1505.

5. The film according to claim 1, wherein said random polypropylene copolymer is a copolymer containing a comonomer selected from ethylene and α-olefin; wherein the α-olefin is linear or branched C₄ to C₁₂.

6. The film according to claim 1, wherein said random polypropylene copolymer is a terpolymer containing any two comonomers selected from ethylene and α-olefin; wherein the α-olefin is linear or branched C₄ to C₁₂.

7. The film according to claim 1, wherein said random polypropylene copolymer is produced with a catalyst selected from single site and Ziegler Natta.

8. The film according to claim 1, wherein said skin layer adjacent to said core layer, or said intermediate layer adjacent to said core layer, comprise at least one ethylene interpolymer.

9. The film according to claim 1, wherein said skin or said intermediate layer comprises at least one homogeneous ethylene interpolymer having a melt index from about 0.1 g/10 minutes to about 15 g/10 minutes, as determined by ASTM D-1238 at 190° C. and 2.16 kg, and a density from about 0.9 g/cm³ to about 0.94 g/cm³, as determined by ASTM D-1505.

10. The film according to claim 1, wherein said skin or said intermediate layer comprises at least one heterogeneous ethylene interpolymer having a melt index from about 0.1 g/10 minutes to about 15 g/10 minutes, as determined by ASTM D-1238 at 190° C. and 2.16 kg, and a density from about 0.9 g/cm³ to about 0.94 g/cm³, as determined by ASTM D-1505.

11. The film according to claim 1, wherein said skin or said intermediate layer comprise a blend of at least one homogeneous interpolymer and at least one heterogeneous interpolymer.

12. The film according to claim 9, wherein said skin or said intermediate layer further comprise an ethylene polymer produced in a high pressure polyethylene process, having a melt index from about 0.2 g/10 minutes to about 10 g/10 minutes, as determined by ASTM D-1238 at 190° C. and 2.16 kg, and a density from about 0.917 g/cm³ to about 0.97 g/cm³, as determined by ASTM D-1505.

13. The film according to claim 10, wherein said skin or said intermediate layer further comprise an ethylene polymer produced in a high pressure polyethylene process, having a melt index from about 0.2 g/10 minutes to about 10 g/10 minutes, as determined by ASTM D-1238 at 190° C. and 2.16 kg, and a density from about 0.917 g/cm³ to about 0.97 g/cm³, as determined by ASTM D-1505.

14. The film according to claim 11, wherein said skin or said intermediate layer further comprise an ethylene polymer produced in a high pressure polyethylene process, having a melt index from about 0.2 g/10 minutes to about 10 g/10 minutes, as determined by ASTM D-1238 at 190° C. and 2.16 kg, and a density from about 0.917 g/cm³ to about 0.97 g/cm³, as determined by ASTM D-1505.

15. The film according to claim 8, wherein said ethylene interpolymer contains one or more comonomers selected from propylene and α-olefin; wherein the α-olefin is linear or branched C₄ to C₁₂.

16. The film according to claim 8, wherein said ethylene interpolymer contains a comonomer selected from 1-hexene and 1-octene.

17. The film according to claim 1 which consists of 5-layers.

18. The film according to claim 1 which consists of 7 layers.

19. The film according to claim 1 which consists of 9 layers.

20. The film according to claim 1 which consists of 11 layers.

21. A coextruded three layer film comprising: a core layer comprising at least one random polypropylene copolymer, an inner skin layer adjacent to said core layer, and an outer skin layer adjacent to said core layer; wherein the coextruded film has improved machine direction tear, as determined by ASTM D-1922, that is at least about 30% higher compared with a core layer comprising at least one impact polypropylene copolymer.

22. The film according to claim 21, wherein said coextruded three layer film has at least about 10% lower film haze, as determined by ASTM D-1003, compared with a core layer comprising at least one impact polypropylene copolymer.

23. The film according to claim 21, wherein said coextruded film has an improved tear ratio, as determined by ASTM D-1922, of at least about 30% higher compared with a core layer comprising at least one impact polypropylene copolymer.

24. The film according to claim 21, wherein said random polypropylene copolymer has a melt index, from about 0.5 g/10 minutes to about 16 g/10 minutes, as determined by ASTM D-1238 at 230° C. and 2.16 kg, and a density from about 0.89 g/cm³ to about 0.91 g/cm³, as determined by ASTM D-1505.

25. The film according to claim 21, wherein said random polypropylene copolymer is a copolymer containing a comonomer selected from ethylene and α-olefin; wherein the α-olefin is linear or branched C₄ to C₁₂.

26. The film according to claim 21, wherein said random polypropylene copolymer is a terpolymer containing any two comonomers selected from ethylene and α-olefin; wherein the α-olefin is linear or branched C₄ to C₁₂.

27. The film according to claim 21, wherein said random polypropylene copolymer is produced with a catalyst selected from single site and Ziegler Natta.

28. The film according to claim 21, wherein said inner skin layer and said outer skin layer comprise at least one ethylene interpolymer; or optionally, said inner and said outer skin layers may differ in chemical composition.

29. The film according to claim 28, wherein said inner and said outer skin layers comprise at least one homogeneous ethylene interpolymer having a melt index from about 0.1 g/10 minutes to about 15 g/10 minutes, as determined by ASTM D-1238 at 190° C. and 2.16 kg; a density from about 0.9 g/cm³ to about 0.94 g/cm³, as determined by ASTM D-1505, and; or optionally, said inner and said outer skin layer may differ in chemical composition.

30. The film according to claim 28, wherein said inner and said outer skin layers comprise at least one heterogeneous ethylene interpolymer having a melt index from about 0.1 g/10 minutes to about 15 g/10 minutes, as determined by ASTM D-1238 at 190° C. and 2.16 kg; a density from about 0.9 g/cm³ to about 0.94 g/cm³, as determined by ASTM D-1505; or optionally, said inner and said outer skin layer may differ in chemical composition.

31. The film according to claim 28, wherein said inner and said outer skin layers comprise a blend of at least one homogeneous ethylene interpolymer and at least one heterogeneous ethylene interpolymer; or optionally, said inner and said outer skin layer may differ in chemical composition.

32. The film according to claim 29, wherein said inner skin layer, or said outer skin layer, or both said inner and said outer skin layers, further comprise an ethylene polymer produced in a high pressure polyethylene process, having a melt index from about 0.2 g/10 minutes to about 10 g/10 minutes, as determined by ASTM D-1238 at 190° C. and 2.16 kg; a density from about 0.917 g/cm³ to about 0.97 g/cm³, as determined by ASTM D-1505; optionally, the chemical composition of said ethylene polymer produced in the high pressure process may differ in said inner and said outer skin layers.

33. The film according to claim 30, wherein said inner skin layer, or said outer skin layer, or both said inner and said outer skin layers, further comprise an ethylene polymer produced in a high pressure polyethylene process, having a melt index from about 0.2 g/10 minutes to about 10 g/10 minutes, as determined by ASTM D-1238 at 190° C. and 2.16 kg; a density from about 0.917 g/cm³ to about 0.97 g/cm³, as determined by ASTM D-1505; optionally, the chemical composition of said ethylene polymer produced in the high pressure process may differ in said inner and said outer skin layers.

34. The film according to claim 31, wherein said inner skin layer, or said outer skin layer, or both said inner and said outer skin layers, further comprise an ethylene polymer produced in a high pressure polyethylene process, having a melt index from about 0.2 g/10 minutes to about 10 g/10 minutes, as determined by ASTM D-1238 at 190° C. and 2.16 kg; a density from about 0.917 g/cm³ to about 0.97 g/cm³, as determined by ASTM D-1505; optionally, the chemical composition of said ethylene polymer produced in the high pressure process may differ in said inner and said outer skin layers.

35. The film according to claim 28, wherein said ethylene interpolymer contains one or more comonomers selected from propylene and α-olefin; wherein the α-olefin is linear or branched C₄ to C₁₂.

36. The film according to claim 28, wherein said ethylene interpolymer contains a comonomer selected from 1-hexene and 1-octene.

37. An article of manufacture comprising at least one component formed from said three layer film of claim 21.

38. An adhesively laminated film, produced by adhesively laminating said three layer film of claim 21 to a substrate selected from polyamide, polyester and polypropylene.

39. An article of manufacture comprising at least one component formed from said adhesively laminated film of claim 38.

40. An extrusion laminated film, produced by extrusion laminating said three layer film of claim 21 to a substrate selected from polyamide, polyester and polypropylene.

41. An article of manufacture comprising at least one component formed from said extrusion laminated film of claim 40.

42. A process for forming a coextruded three layer film using a blown film process: selecting a blown film coextrusion line with two extruders, a core extruder and a skin extruder; or optionally selecting a blown film coextrusion line with three extruders, a core extruder, an inner skin extruder and an outer skin extruder;
tumble blending at least one random polypropylene copolymer to form a core extruder feed and loading said core extruder feed into a core extruder feed hopper;
tumble blending at least one ethylene interpolymer to form a skin extruder feed and loading said skin extruder feed into a skin extruder feed hopper; or optionally, selecting a film line with three extruders, and tumble blending at least one ethylene interpolymer to form an inner skin extruder feed, loading said inner skin extruder feed into an inner skin extruder feed hopper, tumble blending at least one ethylene interpolymer to form an outer skin extruder feed, loading said outer skin extruder feed into an outer skin extruder feed hopper, wherein said inner and said outer skin extruder feeds may differ in chemical composition;
extruding and converting said core extruder feed and said skin extruder feed to form a three layer blown film comprising a core layer, an inner layer and an outer layer, wherein said inner and said outer layers are adjacent to said core layer; or optionally, selecting a film line with three extruders and extruding said core extruder feed, said inner skin extruder feed and said outer skin extruder feed to form a three layer blown film comprising a core layer, an inner layer and an outer layer, wherein said inner and said outer layers are adjacent to said core layer, optionally, said inner and said outer skin layers may differ in chemical composition;
wherein said three layer film has improved machine direction tear, as determined by ASTM D-1922, that is about 30% higher compared with a core layer comprising at least one impact polypropylene copolymer.

43. The film extrusion process according to claim 42, wherein said three layer film has at least about 10% lower film haze, as determined by ASTM D-1003, compared with a core layer comprising at least one impact polypropylene copolymer.

44. The film extrusion process according to claim 42, wherein said three layer film has an improved tear ratio, as determined by ASTM D-1922, of at least about 30% higher compared with a core layer comprising at least one impact polypropylene copolymer.

45. The film extrusion process according to claim 42, wherein said random polypropylene copolymer has a melt index, from about 0.5 g/10 minutes to about 16 g/10 minutes, as determined by ASTM D-1238 at 230° C. and 2.16 kg, and a density from about 0.89 g/cm³ to about 0.91 g/cm³, as determined by ASTM D-1505.

46. The film extrusion process according to claim 42, wherein said random polypropylene copolymer is a copolymer containing a comonomer selected from ethylene and α-olefin; wherein the α-olefin is linear or branched C₄ to C₁₂.

47. The film extrusion process according to claim 42, wherein said random polypropylene copolymer is a terpolymer containing any two comonomers selected from ethylene and α-olefin; wherein the α-olefin is linear or branched C₄ to C₁₂.

48. The film extrusion process according to claim 42, wherein said random polypropylene copolymer is produced with a catalyst selected from single site and Ziegler Natta.

49. The film extrusion process according to claim 42, wherein said inner skin layer and said outer skin layer comprise at least one ethylene interpolymer; optionally, said inner and said outer skin layers may differ in chemical composition.

50. The film extrusion process according to claim 42, wherein said inner and said outer skin layers comprise at least one homogeneous ethylene interpolymer having a melt index from about 0.1 g/10 minutes to about 15 g/10 minutes, as determined by ASTM D-1238 at 190° C. and 2.16 kg; a density from about 0.9 g/cm³ to about 0.94 g/cm³, as determined by ASTM D-1505; optionally said inner and said outer skin layer may differ in chemical composition.

51. The film extrusion process according to claim 42, wherein said inner and said outer skin layers comprise at least one heterogeneous ethylene interpolymer having a melt index from about 0.1 g/10 minutes to about 15 g/10 minutes, as determined by ASTM D-1238 at 190° C. and 2.16 kg; a density from about 0.9 g/cm³ to about 0.94 g/cm³, as determined by ASTM D-1505; optionally said inner and said outer skin layer may differ in chemical composition.

52. The film extrusion process according to claim 42, wherein said inner and said outer skin layers comprise a blend of at least one homogeneous ethylene interpolymer and at least one heterogeneous ethylene interpolymer; optionally, said inner and said outer skin layer may differ in chemical composition.

53. The film extrusion process according to claim 42, wherein said inner skin layer, or said outer skin layer, or both said inner and said outer skin layers further comprise an ethylene polymer produced in a high pressure polyethylene process, having a melt index from about 0.2 g/10 minutes to about 10 g/10 minutes, as determined by ASTM D-1238 at 190° C. and 2.16 kg; a density from about 0.917 g/cm³ to about 0.97 g/cm³, as determined by ASTM D-1505; optionally, the chemical composition of said ethylene polymer produced in the high pressure process may differ in said inner and said outer skin layers.

54. The film extrusion process according to claim 42, wherein said ethylene interpolymer contains one or more comonomers selected from propylene and α-olefin; wherein the α-olefin is linear or branched C₄ to C₁₂.

55. The film extrusion process according to claim 42, wherein said ethylene interpolymer contains a comonomer selected from 1-hexene and 1-octene.

56. The film extrusion process according to claim 42, further comprising an adhesive lamination step, wherein said three layer film is adhesively laminated to a substrate selected from polyamide, polyester and polypropylene.

57. The film extrusion process according to claim 42, further comprising an extrusion lamination step, wherein said three layer film is extrusion laminated to a substrate selected from polyamide, polyester and polypropylene.
